(19) United States
(12) Patent Application Publication
(10) Pub. No.: US 2009/0266430 A1
(43) Pub. Date: Oct. 29, 2009

(54) Air injection assembly for showers

(75) Inventor: Shuifa Yang, Sanming City (CN)

Correspondence Address: MCDERMOTT, WILL & EMERY LLP;Attn: IP Department, 227 WEST MONROE STREET, SUITE 4400, CHICAGO, IL, 60606-5096, US

(73) Assignee: XIAMEN LOTA INTERNATIONAL CO., LTD.

(21) Appl. No.: 12/150,067

(22) Filed: Apr. 24, 2008

(51) Int. Cl. F16K 11/20

(52) U.S. Cl. 137/597

(57) ABSTRACT

An air injection assembly for a shower, comprising a generally cylindrical aspiration pipe. The aspiration pipe has a generally axially disposed bore. The assembly further includes a water guiding tube, having a cone-shaped opening. A generally cylindrical adapter houses the aspiration pipe and the water guiding tube. The generally cylindrical adapter also has air inlet holes that permit fluid communication between the bore of the aspiration pipe, and the ambient air surrounding the air injection assembly.

### TECHNICAL FIELD

This invention relates generally to an assembly for the dispensing and aeration of water, typically water used for bathing, in either a commercial or residential application. This assembly may be retrofitted and installed into an existing shower, or alternatively can be incorporated into the manufacture of a new shower.

### BACKGROUND OF THE INVENTION

Residential shower devices (or “showers”) are well-known in the art. These showers most typically are made of two or more pieces. The first piece is generally an elongated, relatively narrow water supply pipe. The second piece is generally a shorter, wider head portion, which includes discharge holes for dispensing the water.

For purposes of this specification, it will be understood that “showers” shall mean either devices that are held in the hand, and that include discharge holes for the delivery of water, or wall-mounted devices, that also include discharge holes for the delivery of water.

While they are generally satisfactory for residential and commercial use, many of the existing showers suffer from certain shortcomings. Particularly, after use, a certain amount of water is retained within the wide, head portion of the shower. Because the shower is substantially sealed, that water can neither be quickly discharged from the shower, nor evaporate. Part of this water remains adjacent the discharge holes of the head. The municipal water supplied to many parts of the United States is considered to be “hard” water, i.e., water containing a high level of minerals such as calcium. Hard water that cannot escape the shower, and which remains adjacent the discharge holes of the head portion, eventually results in a build-up of encrusted minerals in the area of the discharge holes. Over time, this build-up partially clogs those discharge holes, and results in a lowering of the rate of water flow through the shower.

One typical shower is shown in US Publication No. 2007/0194153. The '153 Publication depicts a shower having a check valve that moves between positions shown in its FIGS. 1 and 2. As described at Paragraph 37 of the '153 Publication, when moved into the position shown in its FIG. 2, this check valve attains a somewhat distorted shape. When this check valve assumes this shape, the valve permits water to pass through the shower, while at the same time abutting against, blocking, and thereby preventing water from exiting the air pathway.

In contrast, when the flow of water to this shower is stopped, the check valve resumes its unstressed shape, and returns to the position shown in FIG. 1. In this position, the check valve moves away from, and does not block, the air pathway. Accordingly, air may enter the shower through the air pathway. Theoretically, the entry of this air into the pathway is intended to permit the draining of any water remaining in the shower.

Some prior art showers also include provisions for the aeration of the incoming water stream. Aeration is the entrainment of air into the water being supplied to the shower. Aeration may occur at any one of several points between the elongated, relatively narrow water supply pipe of the typical shower, and its head portion.

Other prior art showers are shown, for example, in U.S. Pat. Nos. 2,707,624; 2,778,620; 3,797,747; 4,134,548; 4,346,844; 4,573,639; 4,623,095; 5,054,688; 5,381,957; 6,357,675; 7,017,837; and U.S. Published Application No. 2007/0158470.

### SUMMARY OF THE INVENTION

The invention is an air injection assembly for a shower. The shower of the invention facilitates the entrainment of air into a stream of water. The aerated water being discharged through a shower causes that water, in the opinion of some users, to have a “lighter”, more pleasant feel on the skin.

The structure of the invention also ensures the relatively complete draining of residual water from the shower, after the flow of water to the shower has been stopped. This draining is effected by air inlet holes that vent to the atmosphere. The simplicity of the construction of the invention, and its use of such air inlet holes, eliminates the need for costly mechanical check valves.

The air injection assembly of the invention includes an aspiration pipe, preferably with a generally cylindrical shape.

The assembly also includes a water guiding tube, preferably having a cone-shaped opening, for the intake of water into the assembly. The water guiding tube is in fluid communication with the aspiration pipe.

A generally cylindrical air cavity is formed within the assembly. This cavity is disposed between an inner wall of the aspiration pipe and an outer wall of the water guiding tube.

The assembly also includes a generally cylindrical adapter, in which the aspiration pipe and the water guiding tube are disposed or contained. This adapter has air inlet holes, and those air inlet holes are communicative with both the atmosphere and the interior regions of the assembly. In this way, water retained within the head portion of the shower, after the user has finished his shower, can be discharged through the air inlet holes, or more readily evaporate.

The generally cylindrical aspiration pipe may include a pair of flanges, and a circular recess between the flanges.

An O-ring, or other similar sealing device, may be disposed within this circular recess.

In addition, the water guiding tube may include its own, separate pair of flanges. As with the flanges of the generally cylindrical aspiration pipe, the flanges of the water guiding tube can include a circular recess between those flanges.

An O-ring, or other similar sealing device, may also be disposed within the circular recess between the flanges of the water guiding tube.

The generally cylindrical adapter includes a first threaded section at its first lateral end, and a second threaded section at its second lateral end.

Preferably, the first threaded section comprises internally disposed threads. Preferably, the second threaded section includes externally disposed threads.

In addition, the water guiding tube can include a reduced diameter nozzle portion. This reduced diameter nozzle portion is adjacent to one of the distal ends of the cylindrical aspiration pipe.

### BRIEF DESCRIPTION OF THE DRAWINGS

FIG. 1 is a cross-sectional view of one example of the assembled air injection assembly of the invention, showing the three main components of that assembly.

FIG. 2 is an exploded view of the air injection assembly of FIG. 1.

FIG. 3 is a perspective view of the assembled air injection assembly of FIGS. 1 and 2 positioned for retro-fit installation between a wand-style shower and a flexible water supply tube.

FIG. 4 is a cross-sectional view of the fully assembled structure of FIG. 3.

FIG. 5 is an exploded view of the some of the components of the device of FIG. 6.

FIG. 6 is a cross-sectional view of another version of the air injection assembly of the invention, installed by the manufacturer as original equipment into a wand-style shower.

FIG. 7(a) is a cross-sectional view of an air injection assembly in accordance with the invention, installed into a wall-mounted shower.

FIG. 7(b) is an assembled perspective view of the air injection assembly and the wall-mounted shower of FIG. 7(a).

FIG. 7(c) is an exploded view of the air injection assembly and the wall-mounted shower of FIG. 7(b).

FIG. 8 provides various views of an air injection assembly of the invention installed as an original equipment manufacturer (OEM) component of a wall-mounted shower.

### DETAILED DESCRIPTION

While this invention is susceptible of embodiments in many different forms, this specification and these drawings describe an example of the invention. It should be understood that the present disclosure is but one example of the principles of the invention. This disclosure is not intended to limit the broadest aspect of the invention to the illustrated examples.

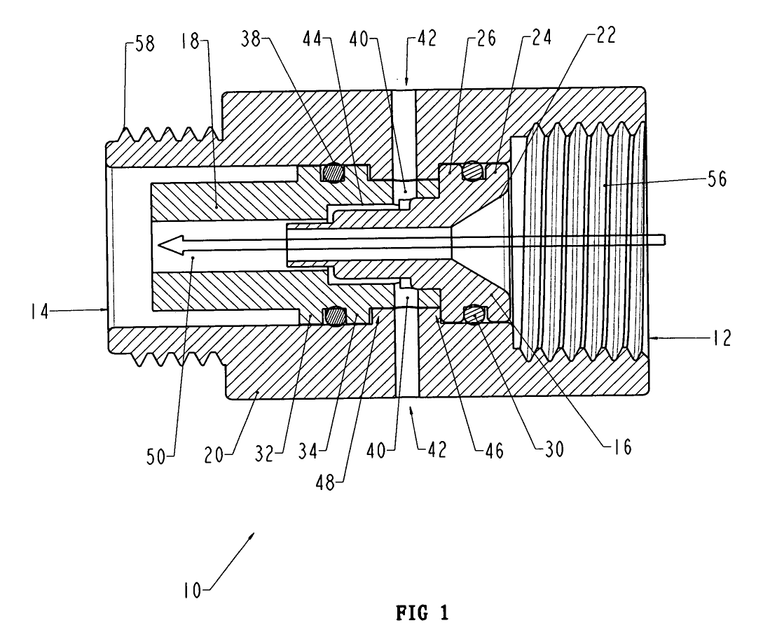

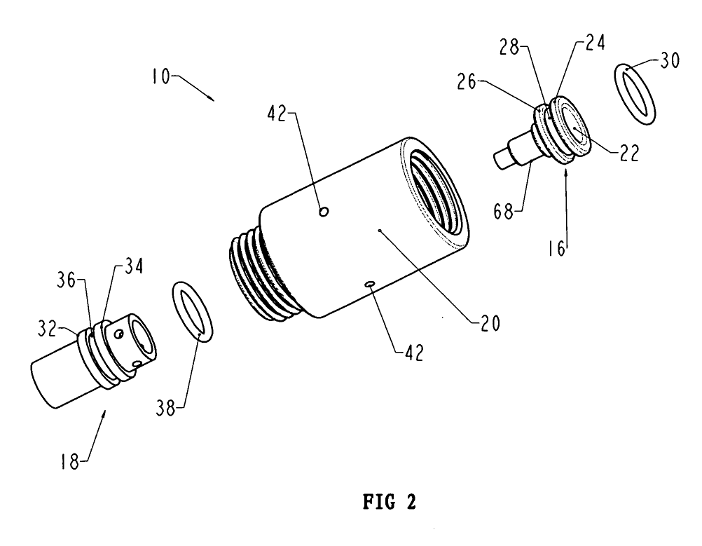

FIG. 1 depicts a cross-sectional view of the three main components of one embodiment of the air injection assembly 10 for a shower. Those three components can best be seen in FIGS. 1 and 2.

Referring now to FIG. 1, water passing through the air injection assembly 10 moves in the direction of the arrows, from a water inlet 12 region on the right of the assembly to a water outlet 14 region on the left of the assembly. Thus, in the embodiment shown in FIG. 1, water flows through the assembly 10 from the right to the left.

The assembly 10 includes three main components. Those three components can also best be seen in FIGS. 1 and 2, and include (a) a water guiding tube 16; (b) an aspiration pipe 18; and (c) a generally cylindrical adapter 20.

The water guiding tube 16 is generally hollow. Preferably, the water guiding tube 16 has a cone-shaped opening 22. Water is ingested into the assembly 10 through this cone-shaped opening 22.

The exterior of the water guiding tube 16 includes a pair of flanges 24 and 26. A circular recess 28 is formed between the flanges 24 and 26. The recess 28 serves as the seating region for an o-ring 30. The water guiding tube also includes a reduced diameter nozzle portion 68.

As may best be seen in FIGS. 1 and 2, the water guiding tube 16 is in fluid communication with the second of the three main components, the aspiration pipe 18.

The aspiration pipe 18 is generally cylindrical in shape. The aspiration pipe 18 is preferably somewhat larger in diameter than the diameter of the water guiding tube 16.

The aspiration pipe 18 also includes a pair of flanges 32 and 34. A circular recess 36 is formed between these flanges 32 and 34. That recess 36 serves as the seating region for an o-ring 38. The aspiration pipe 18 also includes air inlet holes 40 on the periphery, which symmetrically communicate with air inlet holes 42 of the cylindrical adapter 20.

As noted above, the third major element of the assembly 10 is the generally cylindrical adapter 20. As may best be seen in FIG. 1, this adapter 20 has an inner diameter that is sufficiently large to contain both the water guiding tube 16 and the aspiration pipe 18, when the tube 16 and pipe 18 are placed adjacent to each other.

It is necessary to ensure a snug fit between the exterior of the water guiding tube 16 and the upstream, interior walls of the of the adapter 20. In this embodiment, this snug fit results from the abutment of the flanges 24 and 26 with an inner wall of the adapter 20.

It is similarly necessary to ensure a snug fit between the exterior of the aspiration pipe 18 and the downstream, interior walls of the adapter 20. In this embodiment, this snug fit results from the abutment of the flanges 32 and 34 with the inner wall of the adapter 20.

It is desirable to provide an air-tight seal between the water guiding tube 16 and the adapter 20. Such an air-tight seal is provided by the o-ring 30.

It is similarly desirable to provide an air-tight seal between the aspiration pipe 18 and the adapter 20. Such an air-tight seal is provided by the o-ring 38.

As indicated above, the water guiding tube 16 and the aspiration pipe 18 are joined within the cylindrical adapter 20.

Spacing between the water guiding tube 16 and the aspiration pipe 18 result from the abutment of portions of the tube 16 and pipe 18 upon cylindrical seats that are formed within the interior of the cylindrical adapter 20.

Specifically, the movement of the water guiding tube 16 within the cylindrical adapter 20 is limited by the abutment of its flange 26 with a first circular seat 46.

Similarly, the movement of the aspiration pipe 18 within the cylindrical adapter 20 is limited by the abutment of its flange 34 with second circular seat 48.

The air is initially ingested into the assembly 10 through air inlet holes 42 of the adapter 20 into air inlet holes 40 of the aspiration pipe 18. That air ingestion arises from negative pressure or vacuum resulting from the movement of water through the adapter 20.

Using the perspective and directions implied by this FIG. 1, the air moving through the air channel initially moves in a vertical direction, through both the vertical air inlet holes 42 and the air inlet holes 40. The air then is shifted into a horizontal flow path, as it enters and moves through the circular cavity 44.

Finally, as may be seen in FIG. 1, the ingested air moves through a generally L-shaped path and into the bore 50.

In summary, the ingestion of air into the air channel begins at the air inlet holes 42. These air inlet holes 42 are positioned on the exterior surface of the cylindrical adapter 20. Air from the surrounding ambient passes through the air inlet holes 42, and then to the air inlet holes 40.

Air in the air inlet holes 40 then moves into the next portion of the air channel, i.e., a circular, ring-shaped cavity 44. This generally ring-shaped air cavity 44 is formed within the assembly 10, and is disposed between an inner wall of the aspiration pipe 18 and an outer wall of the water guiding tube 16. More particularly, as may be seen in FIG. 1, this generally ring-shaped cavity 44 is formed in a space between the downstream tip 68 of the water guiding tube 16 and a portion of the inner wall of aspiration pipe 18.

Stated in yet another way, the air inlet channel is formed (a) beginning at the air inlet holes 42 on the exterior surface of the adapter 20; (b) continuing though air inlet holes 40 on the periphery of the aspiration pipe; (c) then continuing to the circular air cavity 44, which circular air cavity 44 is the space between the inner wall of the aspiration pipe 18 and the outer wall of the water guiding tube 16.

From the circular cavity 44, the air passes into a bore 50 within the aspiration pipe 18. The air mixes, i.e., becomes entrained, with the water passing through this assembly 10 and this bore 50. The bore 50 is generally axially disposed within the aspiration pipe 18. The bore 50 serves as both a mixing chamber of the air and water, and a flow path for the air-entrained water through the assembly.

As a result of this mixing, air-entrained water is formed. Such air-entrained water is especially useful for bathing in showers. Many bathers perceive that such air-entrained water (otherwise known as “bubble water”) provides a pleasant and less harsh “feel” to the skin.

In addition, some users perceive that less air-entrained water needs to be used during a shower, as compared to the amount of non air-entrained water that such users deem necessary. In this sense, and for such users, air-entrained water may result in both lower water costs and lower water heating costs.

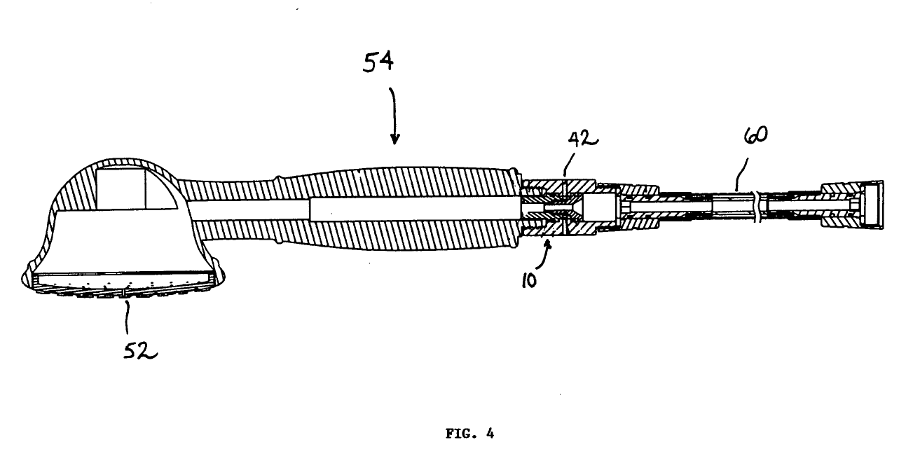

A wand-style shower 54 incorporating the assembly 10 of the invention is depicted in FIG. 4. The discharge end of this wand-style shower includes a plurality of discharge holes 52. The air inlet holes 42 of the assembly 10 assist in preventing the calcification of water within the wand-style shower 54, including but not limited to calcification of water at the discharge holes 52 of the wand-style shower 54.

Particularly, when the flow of water to the wand-style shower 54 is interrupted, some residual water can remain within the wand-style shower 54. The inlet holes 42 permit that residual water to be emptied from the wand-style shower 54.

In addition, the inlet holes 42 permit the entry of air into the wand-style shower 54, and that air facilitates the evaporation of any water remaining in the wand-style shower 54.

After the user has finished his shower, any water retained within the head portion of the wand-style shower 54 can be either discharged through the air inlet holes 42, or evaporated by air entering those inlet holes 42.

Returning now to FIG. 1, the generally cylindrical adapter 20 includes a first threaded section 56 at its water inlet region 12, and a second threaded section 58 at its water outlet region 14.

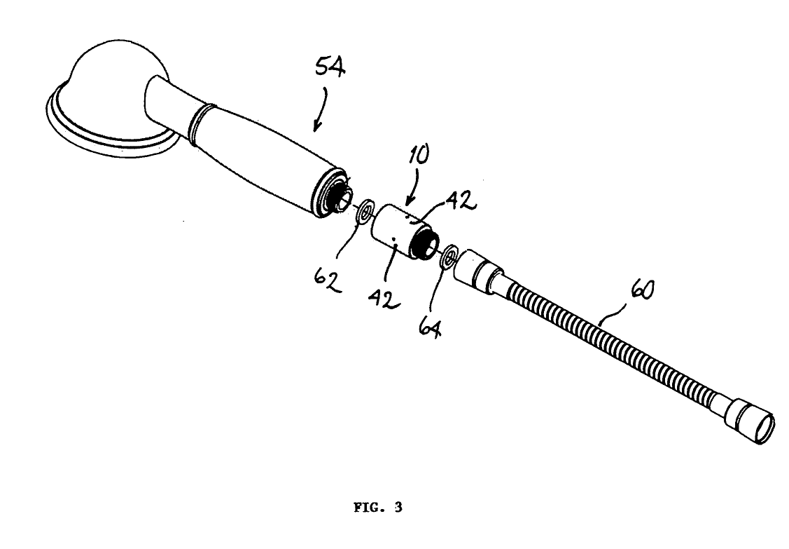

Preferably, the first threaded section 56 is comprised of internally disposed threads. Preferably, the second threaded section 58 is comprised of externally disposed threads. As may be seen in FIG. 3, however, this orientation may be reversed, so that the inlet of the assembly 10 may have external threads.

FIGS. 3-8 show the use of the assembly 10 described above, or of a slight modification of that assembly, in showers of various kinds.

FIGS. 3 and 4 show a hand-held shower 54 that uses the assembly 10 of FIGS. 1 and 2. The assembly 10 is threadably secured between a hand-held shower 54 and a flexible water supply pipe 60. Washers 62 and 64 prevent leakage, as water flows from the flexible water supply pipe 60, through the assembly 10, and then out through the hand-held shower 54. This assembly 10 may be sold separately, to be retro-fitted into pre-existing shower 54 at a residence or business.

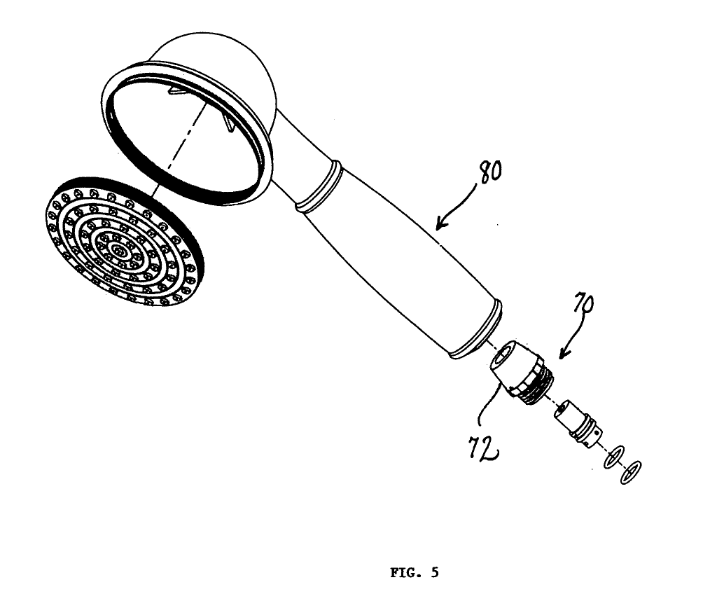

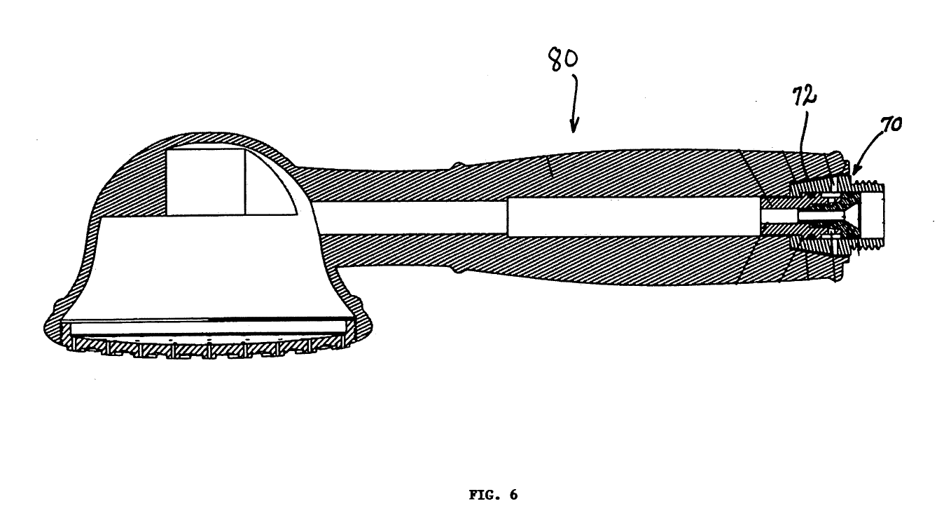

FIGS. 5 and 6 show a hand-held shower 80 that includes an alternative embodiment of the air injection assembly 70 of the invention. In this embodiment, the air injection assembly 70 is installed as an OEM component of the new shower 80. As may best be seen by the cross-sectional view of FIG. 6, the internal and external structures of the air injection assembly 70 of FIGS. 5 and 6 are essentially identical to the internal and external structures of the air injection assembly 10 of FIGS. 1 and 2.

There is, however, one primary, cosmetic difference between the air injection assembly 10 of FIGS. 1 and 2 and the air injection assembly 70 of FIGS. 5 and 6. That difference is the shape of the adapter. The adapter 20 of FIGS. 1 and 2 has a generally cylindrical shape.

In contrast, the air injection assembly 70 of FIGS. 5 and 6 has an adapter 72 with a generally conical shape. This conical shape enables the assembly 70 to be snugly and securely installed, along the complementarily-shaped interior walls at the inlet end of showerhead 80.

The difference in shapes of assemblies 10 and 70 is of no other significance, i.e., the difference in the shapes of these assemblies 10 and 70 has no effect on their operation, performance, or function.

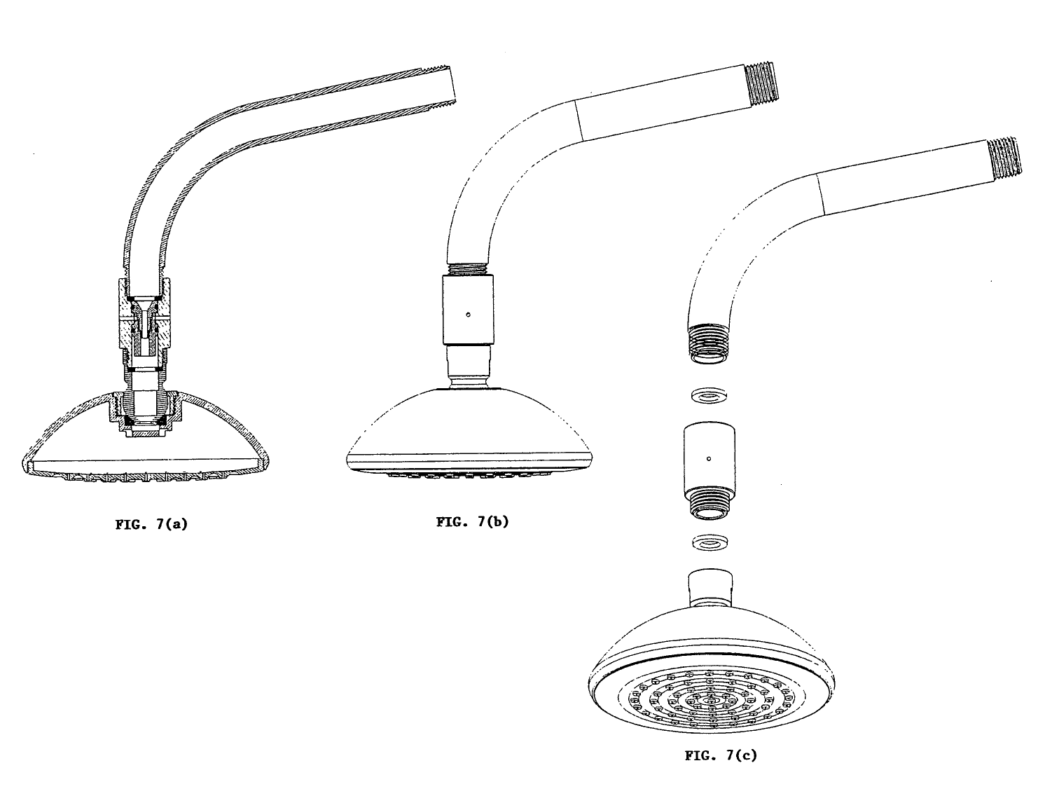

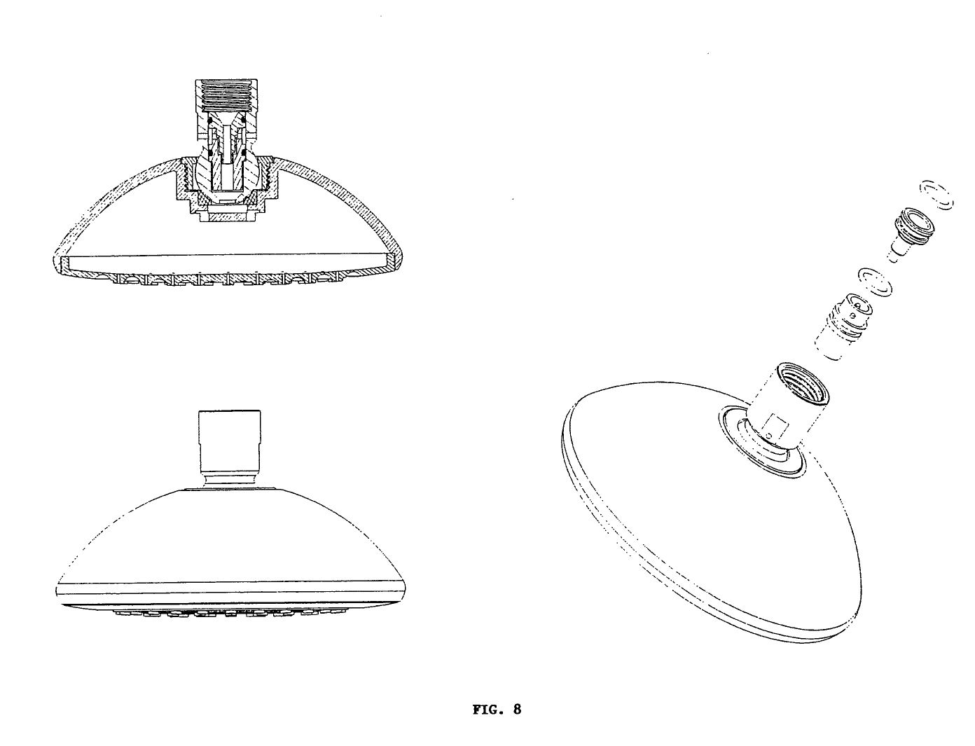

Finally, FIGS. 7(a), 7(b), 7(c), and FIG. 8 depict showers that are not hand-held, but are instead intended to be fixed to a wall of a shower stall. In the shower of FIGS. 7(a), 7(b), and 7(c), the air injection assembly 10 is shown in a retro-fit application. In the shower of FIG. 8, the air injection assembly is an OEM component placed directly into the shower at the factory.

What is claimed is:

1. An air injection assembly for a shower, comprising:
a generally cylindrical aspiration pipe, said aspiration pipe having a generally axially disposed bore and air inlet holes on the periphery;
a water guiding tube, having a cone-shaped opening, and in fluid communication with said aspiration pipe;
a generally cylindrical adapter in which said aspiration pipe and said water guiding tube are disposed, said generally cylindrical adapter having air inlet holes that permit fluid communication between the bore of the aspiration pipe, and the ambient surrounding the air injection assembly.

2. The air injection assembly of claim 1, wherein said generally cylindrical aspiration pipe includes a pair of flanges, and a circular recess between the flanges.

3. The air injection assembly of claim 2, further comprising an O-ring disposed within the circular recess.

4. The air injection assembly of claim 1, wherein said water guiding tube includes a pair of flanges, and a circular recess between the flanges.

5. The air injection assembly of claim 4, further comprising an O-ring disposed in the circular recess.

6. The air injection assembly of claim 1, wherein said generally cylindrical adapter includes a first threaded section at its first lateral end, and a second threaded section at its second lateral end.

7. The air injection assembly of claim 6, wherein said first threaded section comprises internally disposed threads, and said second threaded section comprises externally disposed threads.

8. The air injection assembly of claim 1, wherein said air inlet holes on the periphery of the aspiration pipe which are symmetrically communicated with air inlet holes on the exterior surface of the cylindrical adapter.

9. An air injection assembly for a shower, comprising:
a generally cylindrical aspiration pipe having a pair of flanges, and a circular recess between the flanges for accommodating an O-ring;
a water guiding tube, having a cone-shaped opening, in fluid communication with said aspiration pipe, said water guiding tube including a pair of flanges and a circular recess between the flanges for accommodating an O-ring;
a generally cylindrical air cavity disposed between an inner wall of the aspiration pipe and an outer wall of the water guiding tube;
a generally cylindrical adapter, in which said aspiration pipe and said water guiding tube are disposed, said generally cylindrical adapter having air inlet holes communicative with a water channel within the aspiration pipe, and the ambient surrounding the air injection assembly.

10. The air injection assembly of claim 9, wherein said water guiding tube includes a reduced diameter nozzle portion

11. A combination hand-held shower and air injection assembly for that hand-held shower, wherein the air injection assembly comprises:
a generally cylindrical aspiration pipe, said aspiration pipe having a generally axially disposed bore and air inlet holes on the periphery;
a water guiding tube, having a cone-shaped opening, and in fluid communication with said aspiration pipe;
a generally cylindrical adapter in which said aspiration pipe and said water guiding tube are disposed, said generally cylindrical adapter having air inlet holes that permit fluid communication between the bore of the aspiration pipe, and the ambient surrounding the air injection assembly.

12. The combination set forth in claim 11, wherein said generally cylindrical aspiration pipe includes a pair of flanges, and a circular recess between the flanges.

13. The combination set forth in claim 12, further comprising an O-ring disposed within the circular recess.

14. The combination set forth in claim 11, wherein said water guiding tube includes a pair of flanges, and a circular recess between the flanges.

15. The combination set forth in claim 14, further comprising an O-ring disposed in the circular recess.

16. The combination set forth in claim 11, wherein said generally cylindrical adapter includes a first threaded section at its first lateral end, and a second threaded section at its second lateral end.

17. The combination set forth in claim 16, wherein said first threaded section comprises internally disposed threads, and said second threaded section comprises externally disposed threads.

18. The combination set forth in claim 11, wherein said air inlet holes on the periphery of the aspiration pipe which are symmetrically communicated with air inlet holes on the exterior surface of the cylindrical adapter.

19. A combination wall-mounted shower and air injection assembly for that wall-mounted shower, wherein the air injection assembly comprises:
a generally cylindrical aspiration pipe, said aspiration pipe having a generally axially disposed bore and air inlet holes on the periphery;
a water guiding tube, having a cone-shaped opening, and in fluid communication with said aspiration pipe;
a generally cylindrical adapter in which said aspiration pipe and said water guiding tube are disposed, said generally cylindrical adapter having air inlet holes that permit fluid communication between the bore of the aspiration pipe, and the ambient surrounding the air injection assembly.

20. The combination set forth in claim 19, wherein said generally cylindrical aspiration pipe includes a pair of flanges, and a circular recess between the flanges.

21. The combination set forth in claim 20, further comprising an O-ring disposed within the circular recess.

22. The combination set forth in claim 19, wherein said water guiding tube includes a pair of flanges, and a circular recess between the flanges.

23. The combination set forth in claim 22, further comprising an O-ring disposed in the circular recess.

24. The combination set forth in claim 19, wherein said generally cylindrical adapter includes a first threaded section at its first lateral end, and a second threaded section at its second lateral end.

25. The combination set forth in claim 24, wherein said first threaded section comprises internally disposed threads, and said second threaded section comprises externally disposed threads.

26. The combination set forth in claim 19, wherein said air inlet holes on the periphery of the aspiration pipe which are symmetrically communicated with air inlet holes on the exterior surface of the cylindrical adapter.
